(19) United States
(12) Patent Application Publication
(10) Pub. No.: US 2018/0048849 A1
(43) Pub. Date: Feb. 15, 2018

(54) ELECTRONIC DISPLAY WITH HIGH PERFORMANCE CHARACTERISTICS

(71) Applicant: Manufacturing Resources International, Inc., Alpharetta, GA (US)

(72) Inventor: William Dunn, Alpharetta, GA (US)

(21) Appl. No.: 15/233,807

(22) Filed: Aug. 10, 2016

(51) Int. Cl. H04N 5/64; H04N 5/63; G02F 1/1335

(52) U.S. Cl. CPC H04N 5/64; G02F 1/133603; H04N 5/63

(57) ABSTRACT

The exemplary embodiments herein provide an electronic display having high brightness through continuation operation over a period of 5 to 10 years or more. High ambient temperatures do not affect the luminance output of the exemplary displays. Off angle viewing only affects the luminance output by the display minimally when compared to prior art electronic displays. The displays can produce at least 98% LED efficacy over the span of up to 15 years of continuous operation in an outdoor environment. Exemplary displays maintain at least 85% NTSC color saturation for up to 10 years of continuous operation in an outdoor environment.

### CROSS-REFERENCE TO RELATED APPLICATIONS

This application does not claim priority to a co-pending application.

### TECHNICAL FIELD

Exemplary embodiments relate generally to electronic displays having high brightness, low internal temperatures, and low power consumption for a given screen size.

### BACKGROUND

Electronic displays have become useful for not only indoor entertainment purposes, but are now being utilized for indoor and outdoor advertising/informational purposes. For example, liquid crystal displays (LCDs), plasma displays, OLEDS, and many other flat panel displays are now being used to display information and advertising materials to consumers in locations outside of their own home or within airports, arenas, stadiums, restaurants/bars, gas station pumps, billboards, and even moving displays on the tops of automobiles or on the sides of trucks.

The rapid development of flat panel displays has allowed users to mount these displays in a variety of locations that were not previously available. Further, the popularity of high definition (HD), full high definition (FHD), ultra high definition (UHD) and beyond (here-to-after referred to only as HD) television has increased the demand for larger and brighter displays, especially large displays which are capable of producing HD video. The highly competitive field of consumer advertising has also increased the demand for large displays which are positioned outdoors, sometimes within direct sunlight or other high ambient light situations (street lights, building signs, vehicle headlights, and other displays). In order to be effective, outdoor displays must compete with the ambient natural light to provide a clear and bright image to the viewer.

### SUMMARY OF THE EXEMPLARY EMBODIMENTS

The exemplary embodiments herein provide an electronic display having high luminance with low power consumption and low internal temperatures, even when used in an outdoor environment, sometimes in direct sunlight. Techniques have been employed which allow for large screen sizes, low internal temperatures, low power consumption, and high luminance. Specifically, these electronic displays provide a combination of performance characteristics that were previously unattainable in the industry.

The claimed displays are able to achieve the performance characteristics shown in the figures without the use of air conditioners, de-humidifiers, or electronic heat sinks. These displays are able to perform at a high level, without overloading a local circuit or overheating from high internal temperatures. These displays are also able to remove the solar loading from the front of the LCD so that the internal temperatures are kept low and no damage occurs to the LCD (i.e. solar clearing of the LCD cells and/or permanent thermal damage to the LCD polarizers).

The exemplary embodiments herein disclosed are not intended to be exhaustive or to unnecessarily limit the scope of the embodiments. The exemplary embodiments were chosen and described in order to explain the principles so that others skilled in the art may practice the embodiments. Having shown and described exemplary embodiments, those skilled in the art will realize that many variations and modifications may be made to affect the described invention. Many of those variations and modifications will provide the same result and fall within the spirit of the exemplary embodiments. It is the intention, therefore, to limit the embodiments only as indicated by the scope of the claims.

### BRIEF DESCRIPTION OF THE DRAWINGS

A better understanding will be obtained from a reading of the following detailed description and the accompanying drawings wherein identical reference characters refer to identical parts and in which:

FIG. 1 provides a block diagram for various electronic components which may be used within an exemplary electronic display assembly.

FIG. 2 provides a chart showing the relationship between the luminance of each type of display over the first five years of operation in an outdoor environment.

FIG. 3 provides a chart showing the relationship between the luminance of each type of display in relation to the ambient temperature in an outdoor environment.

FIG. 4 provides a chart showing the relationship between the luminance of each type of display in relation to the viewing angle.

FIG. 5 provides a chart showing the relationship between relative LED efficacy and the years that an exemplary display has been in operation in an outdoor environment.

FIG. 6 provides a chart showing the relationship between relative LED efficacy and the years that a prior art display has been in operation in an outdoor environment.

FIG. 7 provides a chart showing the relationship between color saturation and ambient illumination for both an exemplary display as well as prior art displays over the span of several years of operation in an outdoor environment.

FIG. 8 provides a chart showing the relationship between contrast ratio and ambient illumination for both an exemplary display as well as prior art displays over the span of several years of operation in an outdoor environment.

FIG. 9 provides a chart showing the relationship between luminance and viewing angle, for ambient temperatures of 25° C. and 50° C. for both an exemplary display as well as prior art displays over the span of several years of operation in an outdoor environment.

FIG. 10 provides a chart showing the relationship between the active display area, luminance, and power consumption.

### DETAILED DESCRIPTION OF PREFERRED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

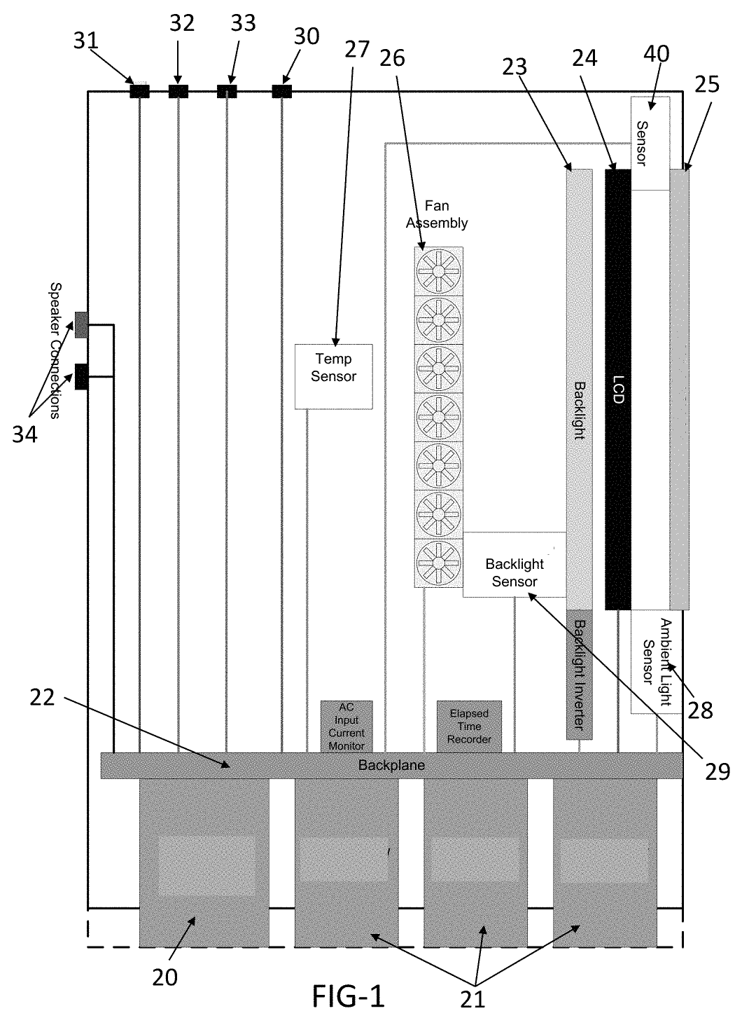

FIG. 1 provides a block diagram for various electronic components which may be used within an exemplary electronic display assembly. One or more power modules 21 may be placed in electrical connection with a backplane 29, which could be provided as a printed circuit board which may facilitate electrical connection and/or power between a number of components in the display assembly. A display controlling assembly 20 may also be in electrical connection with the backplane 22. The display controlling assembly 20 preferably includes a number of different components, including but not limited to a video player, electronic storage, and a microprocessor which is programmed to perform any of the logic that is described within this application.

This figure also shows a backlight 23, LCD assembly 24, and a front transparent display panel 25. The backlight 23 is preferably a light emitting diode (LED) backlight and in an exemplary embodiment the backlight 23 would be a direct-lit LED backlight with dynamic block dimming. A fan assembly 26 is shown for optionally cooling the interior of displays which may reach elevated temperatures. One or more temperature sensors 27 may be used to monitor the temperature of the display assembly, and selectively engage fan assembly 26 when cooling is needed. An ambient light sensor 28 is preferably positioned to measure the amount of ambient light that is contacting the front display panel 25, although this is not required.

A variety of different electrical inputs/outputs are also shown, and all or only a select few of the inputs/outputs may be practiced with any given embodiment. The AC power input 30 delivers the incoming power to the backplane 22. A video signal input 31 can receive video signals from a plurality of different sources. In a preferred embodiment the video signal input 31 would be an HDMI or Display Port input. Two data interface connections 32 and 33 are also shown. The first data interface connection 32 may be an RS2332 port or an IEEE 802.3 jack which can facilitate user setup and system monitoring. Either form of the connection should allow electrical communication with a personal computer. The second data interface connection 33 may be a network connection such as an Ethernet port, wireless network connection, cellular radio, fiber optic, satellite network, or other internet connection. The second data interface connection 33 preferably allows the display assembly to communicate with the internet, and may also permit a remote user to communicate with the display assembly. The second data interface connection 33 can also provide the video data through a network source. The second data interface connection 33 can also be utilized to transmit display settings, error messages, and various other forms of data to a website for access and control by the user. Optional audio connections 34 may also be provided for connection to internal or external speaker assemblies. It is not required that the data inputs 31, 32, and 33 received their data through a wired connection, as many embodiments may utilize wireless networks or satellite networks to transmit data to the display assembly. The various types of wireless/satellite receivers and transmitters have not been specifically shown due to the large number of variable types and arrangements, but these are understood by a person of ordinary skill in the art.

A backlight sensor 29 is preferably placed within the backlight cavity to measure the amount of luminance being generated within the backlight cavity. Additionally, a display luminance sensor 40 is preferably positioned in front of the display 24 in order to measure the amount of luminance exiting the display 24. Either sensor can be used in a traditional feed-back loop to evaluate the control signals being sent to the power modules 21 and what resulting backlight luminance or display luminance is generated by the display in response. As shown below, ambient light data (either actual measurements or artificial ambient light sensor data, herein “AAS”) may be used to select either the desired display luminance or backlight luminance. Either technique can be used with the various embodiments herein.

Information for monitoring the status of the various display components may be transmitted through either of the two data interface connections 32 and 33, so that the user can be notified when a component may be functioning improperly, about to fail, or has already failed and requires replacement. The information for monitoring the status of the display may include, but is not limited to: power supply status, power supply test results, AC input current, temperature sensors, fan speed, video input status, firmware revision, and light level sensors. Also, the user may adjust settings including, but not limited to: on/off, brightness level, enabling ambient light sensor, various alert settings, IP address, customer defined text/video, display matrix settings, display of image settings via OSD, and various software functions. In some embodiments, these settings can be monitored and altered from either of the two data interface connections 32 and 33.

The exemplary displays herein are able to achieve the performance characteristics shown in the figures without the use of air conditioners, de-humidifiers, or electronic heat sinks. These displays are able to perform at a high level, without overloading a local circuit or overheating from high internal temperatures. These displays are also able to remove the solar loading from the front of the LCD so that the internal temperatures are kept low and no damage occurs to the LCD (i.e. solar clearing of the LCD cells and/or permanent thermal damage to the LCD polarizers).

Prior displays had their characteristics measured in a way that did not challenge the display performance with respect to the ambient environment. For example, characteristics for outdoor electronic displays were previously measured under the following conditions:

1. Brand new;

2. Absolute black room . . . zero solar illuminance/zero solar irradiance

3. 25° C. LCD module (or LCM) temperature (not ambient temperature or an even higher ambient temperature);

4. Zero ambient illumination;

5. All measurements are taken at the center of the display;

6. All measurements are taken perpendicular to the plane of the display;

7. Viewing angle stated in black ambient only to a contrast of 10;

8. Color saturation stated only for black ambient;

9. On axis contrast stated only for black ambient;

10. Without regard to a viewer wearing polarized sunglasses (black image or degraded viewing in portrait orientation with polarized sun glasses; and

11. Without any regard to whether the display will go isotropic (i.e., solar clear or develop permanent black spots when exposed to the sun).

However, the exemplary display characteristics detailed herein, as shown in the figures and charts below, were measured under the following conditions:

1. Any ambient temperature (typically −40° C. to +50° C., but the exemplary displays can handle below −50° C. and at least +55° C., with some figures indicating specific temperatures);

2. Any solar irradiance from 0 to 1250 watts/m2;

3. Any solar illuminance from 0 to 100,000 lux;

4. All luminance measurements are taken after the light has passed through any exterior protective display glass, i.e. the luminance that actually hits the eye is measured;

5. All measurements are taken perpendicular to the plane of the display (unless specified as an off-angle viewing);

6. If driven to a specific display luminance (ex. 3500 nit) the electronic display must maintain the specific luminance under any combination of conditions 1-5 above;

7. All optical parameters can be measured over any combination of conditions 1-5 above;

8. If having a specific level of specular and diffuse reflection, maintaining this through any combination of conditions 1-5 above;

9. No visible degradation when viewed in any orientation with polarized sun glasses;

10. Guaranteed to have zero solar clearing under any combination of conditions 1-5 listed above; and

11. All measurements are taken at the center of the display.

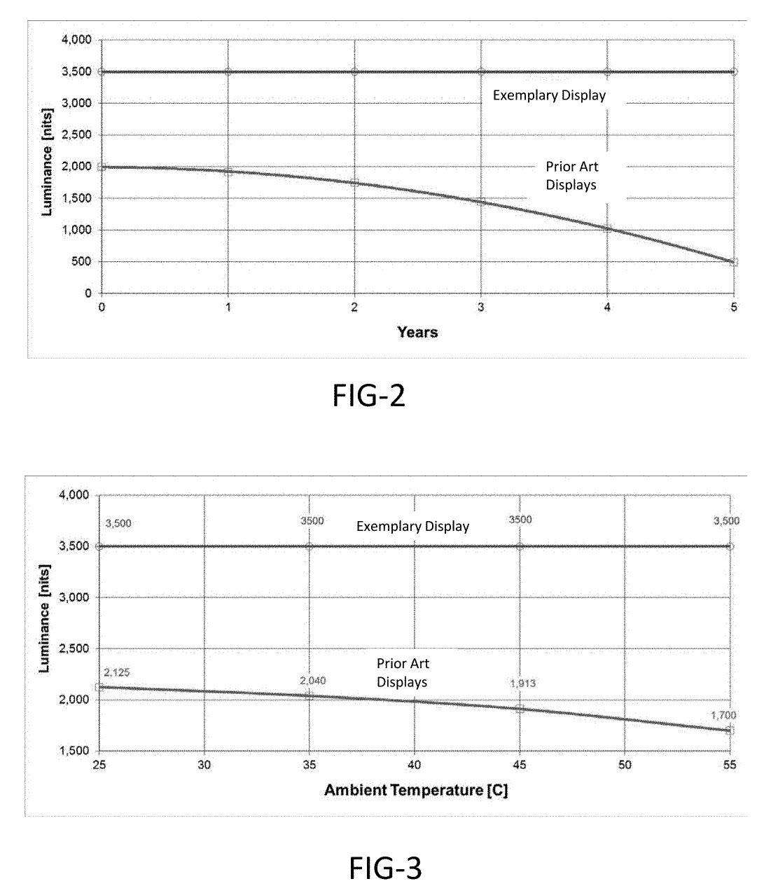

FIG. 2 provides a chart showing the relationship between the luminance of each type of display over the first five years of operation in an outdoor environment. Regarding the exemplary embodiment of an electronic display, the luminance begins at 3,500 nits at time zero, and the display maintains this level of luminance at least through the first five years of operation (often times much longer). In contrast, the prior art displays struggle to even obtain any amount of luminance over 2,000 nits, even at time zero. As the prior art displays continue operating in an outdoor environment, the luminance output by the prior art displays will begin to drop drastically after year 1, falling to less than 1,500 nits at year 3, and finishing at approximately 500 nits at year 5. As shown, the ability to maintain the initial level of luminance throughout years of operation in an outdoor environment, is a performance feature that is only found in the exemplary displays herein.

FIG. 3 provides a chart showing the relationship between the luminance of each type of display in relation to the ambient temperature in an outdoor environment. The exemplary display maintains a luminance output of 3,500 nits through the entire ambient temperature range of 25° C. to 55° C. In contrast, the prior art displays can obtain only 2,125 nits at 25° C., and drop below 2,000 nits once the ambient temperature reaches 40° C. Once the ambient temperature reaches 55° C., the prior art displays are down to only 1,700 nits.

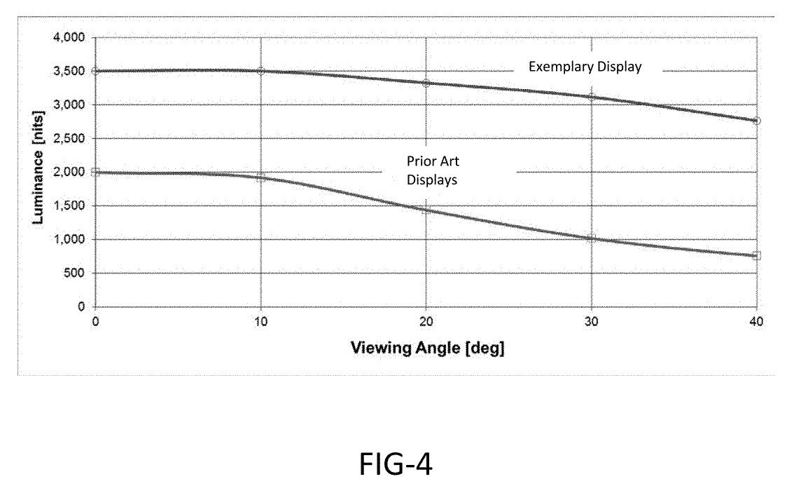

FIG. 4 provides a chart showing the relationship between the luminance of each type of display in relation to the viewing angle. The exemplary displays maintain the 3,500 nits luminance level at viewing angles up to 10 degrees, and while the prior art displays begin at 2,000 nits, they have dropped below this level of luminance, even at only 10 degrees. At 30 degrees, the exemplary display has only lost approximately 400 nits (a reduction of only about 11% of total luminance). In contrast, at 30 degrees, the prior art displays have lost 1,000 nits (a reduction of about 50% of total luminance).

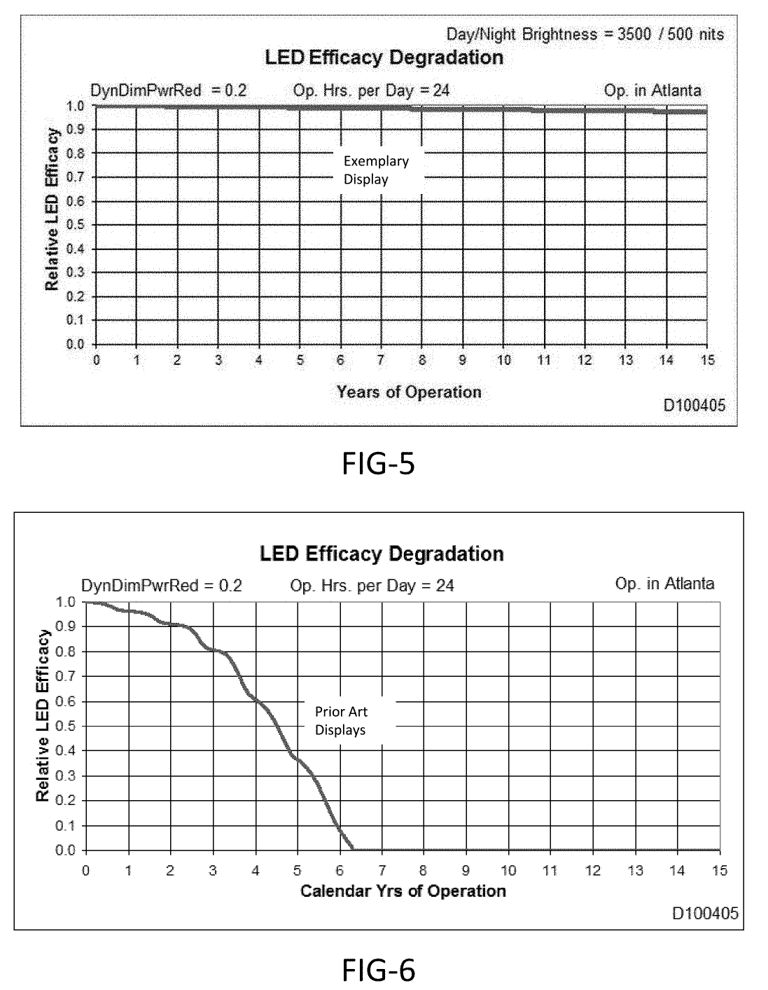

FIG. 5 provides a chart showing the relationship between relative LED efficacy and the years that an exemplary display has been in operation in an outdoor environment. LEDs will degrade over time, especially when they are exposed to high temperatures at the LED junction. As noted above, the exemplary displays maintain optimal performance even in high ambient environments, such that the ability to remove heat from the LEDs will increase both their efficacy and lifetime. As indicated in this chart, the exemplary displays maintain at least 99% of the initial LED efficacy levels for up to 5-6 years. From there, the exemplary displays maintain at least 97% of the initial LED efficacy levels for up to 15 years of continuous (24 hours/day) operation.

FIG. 6 provides a chart showing the relationship between relative LED efficacy and the years that a prior art display has been in operation in an outdoor environment. Here we see a stark contrast to the LED degradation shown in FIG. 5 for the exemplary displays. For the prior art displays, the LED efficacy will degrade by 20% within the first 3 years alone. At 4.5 years, the LED efficacy has degraded by half. Finally, just past year 6, the LED efficacy has gone all the way to zero.

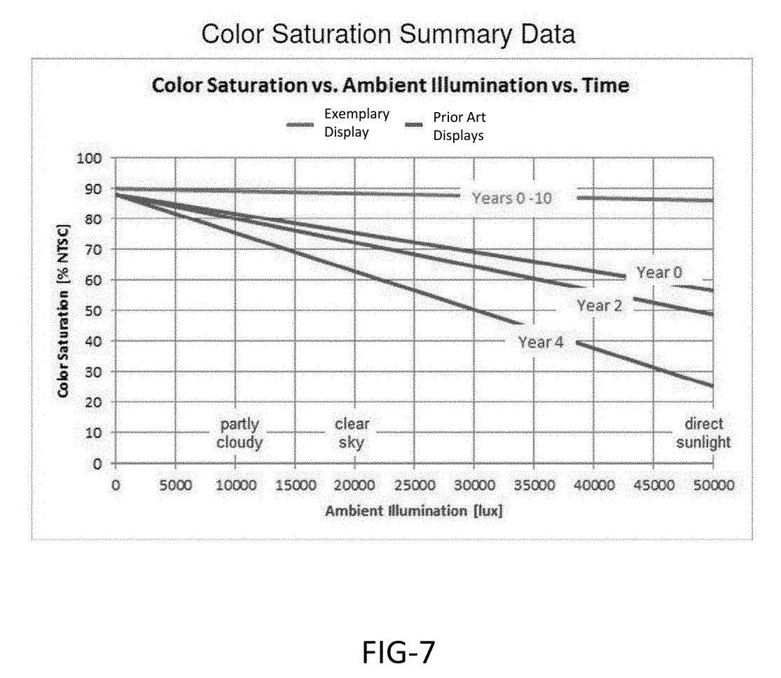

FIG. 7 provides a chart showing the relationship between color saturation and ambient illumination for both an exemplary display as well as prior art displays over the span of several years of operation in an outdoor environment. For the prior art displays in Year 0, the color saturation decreases substantially as the ambient light levels increase. In other words, as the sun gets brighter, there is drastically less color saturation in the display images. After starting in a very dark environment at almost 88% NTSC, the display's color saturation drops to only 58% at high ambient light levels. This trend only gets worse as the prior art displays age. For example, looking at Year 4, when the prior art displays are in direct sunlight, the color saturation has dropped to only 25%. In contrast, the exemplary displays begin at 90% NTSC and even after 10 years of use in an outdoor environment, the color saturation in direct sunlight has only dropped to approximately 86%.

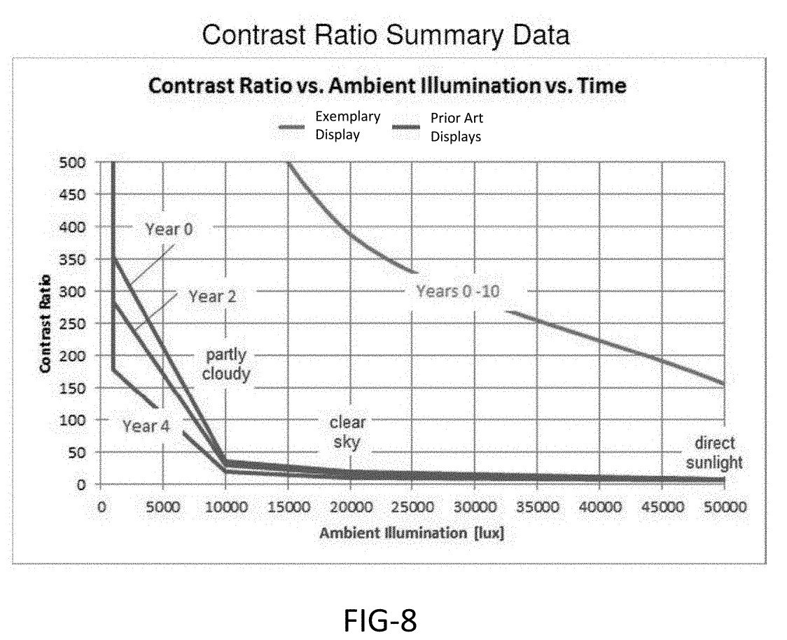

FIG. 8 provides a chart showing the relationship between contrast ratio and ambient illumination for both an exemplary display as well as prior art displays over the span of several years of operation in an outdoor environment. For the prior art displays, high contrast ratios are only achieved when the ambient illumination is very low, on the order of only 1,000 lux. However, once the ambient illumination levels reach 5,000 lux, the contrast ratio has already started to decline drastically. At this point for Year Zero, the contrast ratio is approximately 225, while for the exemplary displays, the contrast ratio is well above 500. Again, as the years of usage in the prior art displays increase, the contrast ratio decreases even further. For Year 4, at 5,000 lux, the contrast ratio for the prior art displays is only at 100. Regardless of the year in usage, the prior art displays cannot exceed a contrast ratio of 50, once the ambient illumination is above 10,000 lux (essentially a partly cloudy environment).

However, the exemplary displays herein can maintain a much higher contrast ratio, well into high levels of ambient illumination, and up to 10 years of continuous outdoor usage. At the point where the ambient illumination reaches 10,000 lux (partly cloudy day) the exemplary displays are still well above 500. Even going to the most extreme case, where the ambient illumination is 50,000 lux (direct sunlight) and the exemplary display has been in operation for 10 years, the contrast ratio is still above 150, while the prior art displays have dropped to near zero.

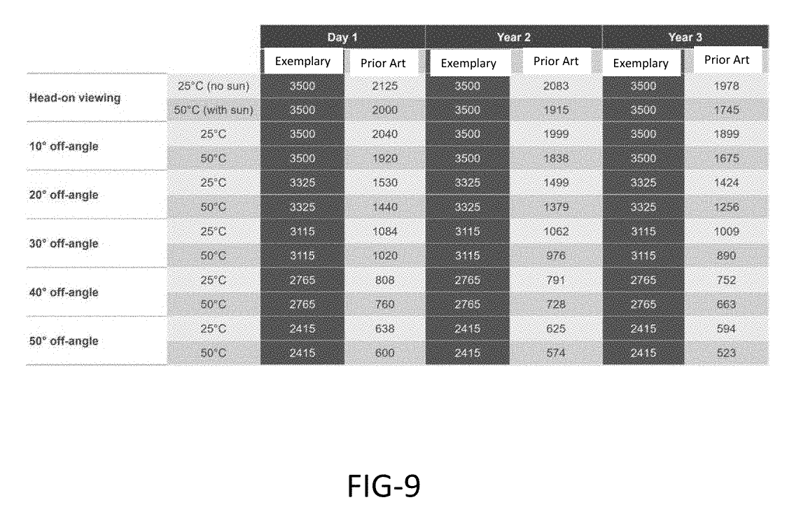

FIG. 9 provides a chart showing the relationship between luminance and viewing angle, for ambient temperatures of 25° C. and 50° C. for both an exemplary display as well as prior art displays over the span of several years of operation in an outdoor environment. This chart provides another comparison between prior art displays and the exemplary displays herein, using data similar to that which was used above.

Again we see that no matter what the ambient temperature is (either 25° C. or 50° C.) the luminance of the exemplary displays herein does not change. In stark contrast, the luminance from the prior art displays will decrease as the ambient temperatures increase. Also, as the years of operation increase (from Day 1 through Year 3 of operation in an outdoor environment) the exemplary displays herein do not see a drop in luminance. However, the prior art displays see a significant drop in luminance as the years of operation increase. For example, while beginning at 2125 nits at 25° C. and head-on viewing on Day 1, this luminance has dropped to only 1978 nits under the same conditions at Year 3. We also see the off angle viewing luminance for the prior art displays dropping from 2125 nits at head-on viewing and 25° C., to only 638 nits at 50° off-angle viewing and 25° C. In comparison, the exemplary displays herein begin at 3500 nits for head-on viewing at 25° C., and only decrease to 2415 nits for 50° off-angle viewing at 25° C.

Specifically regarding the internal temperature rises within the prior electronic displays, once they are turned on, and particularly once you ramp the power in the backlight to product 2000+ nits though the LCD and its associated cover glass while a white image is being displayed, the backlight unit (BLU) temperature, and by conduction and radiation the LCM temperature, begins to rise rapidly. In the prior electronic displays, they will see LED junction temperatures hitting 90° C.+ while in a 25° C. ambient temperature, with zero solar load and with the display cooling systems running at maximum performance.

In contrast, the junction temperatures of the exemplary displays described herein do not exceed a 25° C. rise above ambient when the display is producing 3500 nits of white luminance to the eyeball of a viewer. Therefore, in a 50° C. ambient environment, with 1250 watts/m2 of solar irradiance on the face of the display, the BLU LED junction temperature for the displays herein will be under +75° C.

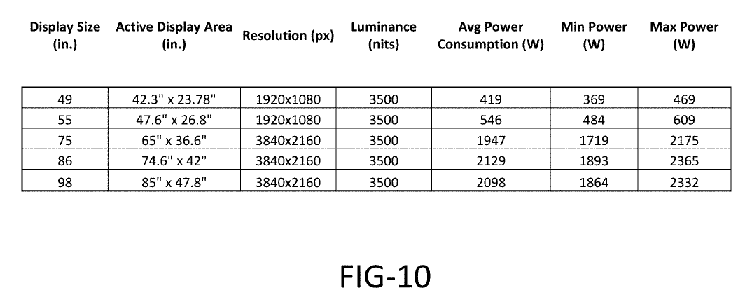

FIG. 10 provides a chart showing the relationship between the active display area, luminance, and power consumption. The values shown were determined for a new unit at time zero. To determine the minimum power consumed, an ambient temperature of 25° C. was applied to the display. To determine the maximum power consumed, an ambient temperature of 50° C. was applied to the display. Any solar irradiance from 0 to 1250 watts/m² was applied to the display during the determination of the power draw.

Having shown and described preferred embodiments, those skilled in the art will realize that many variations and modifications may be made to affect the described embodiments and still be within the scope of the claims. Thus, many of the elements indicated above may be altered or replaced by different elements which will provide the same result and fall within the spirit of the claimed embodiments. It is the intention, therefore, to limit the invention only as indicated by the scope of the claims.

What is claimed is:

1. An apparatus, comprising:
a liquid crystal display in a weatherproof chassis where said display is viewable through said chassis, said display having a display size between 50 and 55 inches measured diagonally;
an LED backlight in said chassis and behind said display;
a power module electrically connected to said backlight; and
a video player electrically connected to said power module and said display;
wherein said display is adapted to achieve luminance levels of at least approximately 3500 nits while a solar load of 1250 watts/m² is applied to the display, and the display draws no more than 609 watts of power when exposed for at least one hour to an ambient temperature of 50° C.

2. An apparatus, comprising:
a liquid crystal display in a weatherproof chassis where said display is viewable through said chassis, said display having a display size between 80 and 86 inches measured diagonally;
an LED backlight in said chassis and behind said display;
a power module electrically connected to said backlight; and
a video player electrically connected to said power module and said display;
wherein said display is adapted to achieve luminance levels of about 3500 nits, while the ambient temperatures surrounding the display are between about 25° C. and about 50° C., and the power drawn by the display does not exceed 2,365 watts.

3. The apparatus of claim 2 wherein:
the apparatus maintains the luminance level even after said apparatus has been operating for at least one hour in an outdoor environment of at least 50° C.

4. The apparatus of claim 2 wherein:
the apparatus maintains the luminance level even when measured at angles up to 10 degrees from perpendicular to the plane of the display.

5. The apparatus of claim 2 wherein:
the apparatus maintains the luminance level even after 3 years of operation in an outdoor environment.

6. The apparatus of claim 2 wherein:
the apparatus draws less than 1,900 watts when exposed to ambient temperatures of approximately 25° C.

7. The apparatus of claim 2 wherein:
the apparatus maintains the luminance level with no visible degradation when viewed with polarized sunglasses.

8. The apparatus of claim 2 wherein:
the apparatus maintains the luminance level with no solar clearing.

9. An apparatus, comprising:
a liquid crystal display in a weatherproof chassis where said display is viewable through said chassis;
an LED backlight in said chassis and behind said display;
a power module electrically connected to said backlight; and
a video player electrically connected to said power module and said display;
wherein said display is adapted to achieve luminance levels of 3500 nits or greater for up to 5 years of continuous operation in an outdoor environment, with an ambient environment between 25° C. and 55° C.

10. The apparatus of claim 9 wherein
the apparatus maintains said luminance level at viewing angles from zero to 10 degrees off-angle viewing.

11. The apparatus of claim 9 wherein:
the apparatus maintains at least 95 LED efficacy through the 5 years of continuous operation in an outdoor environment.

12. The apparatus of claim 9 wherein:
the apparatus maintains a color saturation of at least 85% NTSC through the 5 years of continuous operation in an outdoor environment.

13. The apparatus of claim 9 wherein:
the apparatus maintains a color saturation of at least 85% NTSC in ambient lighting conditions varying from zero lux to 50,000 lux.

14. The apparatus of claim 9 wherein:
the apparatus maintains a contrast ratio of at least 150 through the 5 years of continuous operation in an outdoor environment.

15. The apparatus of claim 9 wherein:
the apparatus maintains a contrast ratio of at least 150 through ambient lighting conditions varying from zero lux to 50,000 lux.

16. An apparatus, comprising:
a liquid crystal display in a weatherproof chassis where said display is viewable through said chassis;
an LED backlight in said chassis and behind said display;
a power module electrically connected to said backlight; and
a video player electrically connected to said power module and said display;
wherein said display is adapted to achieve luminance levels of 3500 nits within an ambient environment between 25° C. and 55° C. and at viewing angles between zero degrees and 10 degrees off-angle.

17. The apparatus of claim 16 wherein:
the apparatus maintains said performance characteristics through 5 years of continuous operation in an outdoor environment.

18. The apparatus of claim 16 wherein:
the apparatus maintains at least 95 LED efficacy through the 5 years of continuous operation in an outdoor environment.

19. The apparatus of claim 16 wherein:
the apparatus maintains the luminance level of 3500 nits with no solar clearing.

20. The apparatus of claim 16 wherein:
the apparatus maintains the luminance level of 3500 nits with no degradation in image quality when viewed with polarized sunglasses.
